(19) United States
(12) Patent Application Publication
(10) Pub. No.: US 2008/0256003 A1
(43) Pub. Date: Oct. 16, 2008

(54) Gift equity mortgage (GEM)

(76) Inventor: Kathryn L. Maxey, Fishers, IN (US)

Correspondence Address: Kathryn L. Maxey, 10641 Burning Ridge Lane, Fishers, IN, 46037, US

(21) Appl. No.: 12/080,037

(22) Filed: Mar. 31, 2008

Related U.S. Application Data
(60) Provisional application No. 60/922,749, filed on Apr. 10, 2007.

(51) Int. Cl. G06Q 90/00

(52) U.S. Cl. 705/500

(57) ABSTRACT

This program allows for lien holders, owners, financial institutions their agents/agency's or any seller of Real Estate in which the property was acquired by the prior mortgagor/borrower defaulting on the mortgage/financial terms of there agreement in which real property was use as security for the terms agreed upon. These properties will now be referred to as Real Estate Owned (REO).

Once the REO becomes the property of the lien holder the property is to be sold at current market value. Current market value is determined by an appraisal. Appraised value and purchase price become one in the same.

Once the REO owner has determined the amount they will accept for the property 1-99% less than the purchase price/appraised value. The new buyer will obtain a mortgage for the amount pre disclosed by the REO owner. The difference between the two will become a Gift of Equity. The Gift of Equity will be in the form of a soft second. Soft second meaning as long as pre disclosed conditions are met by the new buyer there will be no re payment required of the soft second.

I claim benefit of the filing of: application No. U.S. 60/922,749 Apr. 10, 2007

### BACKGROUND

This mortgage program was created for several reasons. We have seen a big surge in foreclosures. These foreclosures have had a hard impact on our economy. Causing property values to drop which in turn will cause the tax base to go up. Sellers of the foreclosed properties are taking tremendous losses. With the Gift Equity Mortgage (GEM) offered to owner occupants only, along with other program guidelines, will help in stabilizing property values. Because the sales price is the same as the appraised value. The owner of the foreclosed property has determined what amount they will accept for the property the difference between the purchase price/appraised value and the amount the seller will accept for the property becomes the gift of equity that will be given to the new own occupant of the property. This gift of equity will be given in the form of a soft second. The soft second would have pre disclosed conditions that once met would allow for the soft second to be forgiven by the seller of the foreclosed property.

Thus helping to maintain neighborhood and market values. Allowing the new buyer to receive instant equity as long as the conditions of the program have been met. And lessen losses to the lender by allowing the property to be marketed at a predetermined price to owner occupants only.

### SUMMARY

Because typically investors will pay well below market value and that is the amount of record for most multiple listing services which is one of the ways appraisers use to determine property values and the sales disclosure that will be filed for tax records to determine property tax amounts. This can cause, and has had, a downward spiral in market values and deepen losses to sellers of foreclosed properties.

The GEM is a win win win.

### BRIEF DESCRIPTION

Owner occupants get the advantage of a GIFT of Equity
Purchase price and appraised value help maintain property values
Keeping property values up helps to keep tax base lower
Sellers predetermined sells price help lessen losses to the seller
Boosting the economy

### BRIEF DESCRIPTION OF THE DRAWING

| | |
|---|---|
| Appraised value/Purchase price | $100,000.00 |
| REO owner's pre determined lesser amount | $90,000.00 |
| Gift of Equity/soft second from REO Owner | $10,000.00 |
| to new buyer | |
| New buyers Mortgage | $90,000.00 |
| New buyers Loan to Value | 90% |
| Sales price of home | $100,000.00 |

1) The Gift Equity Mortgage (GEM) is a mortgage loan made to mortgagors who are buying properties that are currently owned or under the control of financial institutions (or their agents) (“seller”) who were involved in the prior mortgage, financing or using real property as a security and took title to the property because of a default by the prior mortgagor.

2) the mortgage in claim 1 is made to a mortgagor who is paying a market price for the property as mutually agreed upon with the property seller and said price will be supported by an independent real estate appraiser

3) the mortgagor in claim 2 is accepting a gift from the financial institution (“seller”) of the property in the form of equity in the property (“gift equity”)

4) the gift equity in claim 3 will reduce the mortgage amount needed to purchase the property in a dollar for dollar manner and will be in the form of a second mortgage

5) the second mortgage debt in claim 4 will not have any payment requirements and will be forgiven according to certain provisions outlined.

6) the maximum mortgage amount allowed in claim 2 will be the purchase price less the gift equity

7) the mortgagor from claims 1 will agree to certain contractual provisions to ensure the mortgagor qualifies for and remains in compliance with the GEM mortgage program,

8) such provisions may include the following and may change from time to time as market conditions allow and require. Adhering to these provisions will also make the mortgagor eligible to have the second mortgage debt forgiven: they will be occupants of the property for at least 3 years, they will make the payments on the GEM in a timely manner
